(19) United States
(12) Patent Application Publication
(10) Pub. No.: US 2010/0241298 A1
(43) Pub. Date: Sep. 23, 2010

(54) Electric powered outdrive

(76) Inventors: Raymond Anthony Sinke, Hartland, MI (US); Chad Anthony Sinke, Hartland, MI (US)

Correspondence Address: Michael T. Raggio;Raggio & Dinnin, P.C., Ste. 410, 2701 Cambridge Court,, Auburn Hills, MI, 48326, US

(21) Appl. No.: 12/661,502

(22) Filed: Mar. 18, 2010

Related U.S. Application Data
(60) Provisional application No. 61/162,047, filed on Mar. 20, 2009.

(51) Int. Cl. B62D 59/04; G06F 19/00

(52) U.S. Cl. 701/22; 180/13; 180/65.21

(57) ABSTRACT

A self contained electric powered out drive system that can be charged overnight by means of a standard 120 volt AC wall outlet. The electric powered out drive system is capable of being attached to the rear of any motor vehicle by means of a standard trailer hitch receiver. The self contained electric drive system assists in propelling a motor vehicle under predetermined driving conditions which will greatly improve a motor vehicles fuel economy.

This Application Claims the Benefit of Priority From U.S. Provisional Patent Application Ser. No. 61/162,047—Filed: Mar. 20, 2009

### BACKGROUND OF THE INVENTION

1. Field of the Invention

The present invention generally relates to a hybrid out drive for use with a vehicle, and more particularly, relates to an electric powered out drive system that is attached to the rear of a vehicle by means of a standard trailer or hitch receiver, to assist in propelling a motor vehicle in certain driving conditions to improve the vehicle's fuel economy.

2. Description of Related Art

Hybrid vehicles are well known and widely used in the prior art. There are many different types of hybrid vehicles, including but not limited to full electric hybrids, partial hybrids, flex fuel vehicles, fuel cell vehicles, bio diesel vehicles, and the like. There also have been numerous attempts in the prior art to use electric fifth wheel type pusher hybrids that either drop from a predetermined portion of the frame of an internal combustion engine vehicle or are connected to a trailer that is pulled behind an internal combustion engine vehicle and the like. Many of these prior art hybrid pusher mechanisms rely on and are connected to the vehicles internal computer systems to monitor the vehicle parameters and status of certain vehicle functions in order to determine the best use of the hybrid assist mechanism that may be connected to the vehicle via either a trailer or other incorporation into a vehicle frame.

Many of these prior art hybrid vehicle assist mechanisms are very complex and require in depth knowledge and changes to the existing vehicle in order to incorporate the hybrid assist drive system into the architecture of the internal combustion engine vehicle. Furthermore, many of these hybrid assist mechanisms are connected via a hitch ball to the vehicle and are mounted on a trailer to help and assist moving of the vehicle via the trailer mechanism connected via a ball hitch to the vehicle. Many of these systems integrate into the electronic control system and onboard computers of the internal combustion vehicles in order to provide power at appropriate times according to the driving conditions the vehicle is experiencing.

Therefore, there is a need in the art for an electric powered out drive that is easy to install and is a self contained unit that requires no connection and communication with the onboard electronic and computer system of the internal combustion engine vehicle on which the electric powered out drive is being used. Furthermore, there is a need in the art for an improved electric powered out drive that is capable of being secured within the trailer hitch receiver of a motor vehicle. Furthermore, there is a need in the art for a completely self contained and self operable onboard computer system for an electric powered out drive that does not rely on the internal combustion vehicle for any power needs, speed data and the like. There also is a need in the art for a self contained electric drive system that is capable of positioning its drive wheel in either a storage position or a drive position depending on the parameters sensed by the onboard controllers of the electric powered out drive. There also is a need in the art for an easy to install electric powered out drive system that incorporates plug and play technology into the electric powered out drive hybrid system. There also is a need in the art for an improved electric powered out drive that is easy to manufacture and is easy to perform repairs thereon. There also is a need in the art for a low cost and light weight hybrid assist system that is capable of improving fuel economy without greatly increasing the vehicle weight and without greatly affecting the vehicle dynamics and the vehicle computer controlled systems.

### SUMMARY OF THE INVENTION

One object of the present invention may be to provide an improved hybrid assist system for a vehicle.

Another object of the present invention may be to provide an electric powered out drive system for use with a vehicle having a trailer hitch receiver.

Still another object of the present invention may be to provide an electric powered out drive system that is capable of swinging a drive wheel between a storage position and a drive position with relation to the vehicle.

Yet a further object of the present invention may be to provide an electric powered out drive system that is completely self contained with its own controller, computer system and batteries self contained on the electric powered out drive.

Still another object of the present invention may be to provide an electric powered out drive system that does not need to connect with and monitor the vehicle onboard computer and telematics therein.

Still another object of the present invention may be to provide an electric powered out drive system that includes an accelerometer arranged thereon to determine acceleration of the vehicle to which the electric powered out drive is connected.

Still another object of the present invention may be to provide an electric powered out drive system that automatically will move the drive wheel into a drive position or storage position depending on the speed, direction and other parameters associated with the electric powered out drive system.

Still another object of the present invention may be to provide a hybrid electric powered out drive that is capable of being charged by a standard 120 volt AC outlet.

Still another object of the present invention may be to provide an electric powered out drive for use with the vehicle that has a system controller that will monitor activation conditions and deactivation conditions for a drive wheel, electric motor output on conditions and electric motor output off conditions continuously to provide assistance to the vehicle, via the drive wheel, in the most effective and efficient manner.

Yet another object of the present invention may be to provide an electric powered out drive that is light in weight, easy to install and provides an approximate 15 to 60 percent improvement over regular fuel mileage under predetermined conditions.

Still another object of the present invention may be to provide an easy to install and easy to use plug and play type electric powered out drive that requires no user intervention after being attached to a vehicle's trailer hitch receiver and plugged into the trailer wiring harness of a vehicle.

According to the present invention, the foregoing and other objects and advantages are obtained by a novel design for an electric powered out drive system for use with a vehicle. The out drive comprises a housing and at least one battery arranged in the housing. The out drive also comprises an adjustable mount member contacting the housing in the vehicle and a steering pivot connected to the mount member. A swing arm is connected to the steering pivot and a wheel is attached to an end of the swing arm. The out drive also comprises an air shock arranged between the steering pivot and the wheel and a suspension pivot connected to the steering pivot. The out drive also has an electric motor secured to the swing arm and in communication with the wheel. The out drive system is attached to the rear of any motor vehicle by means of a standard trailer hitch receiver to assist in propelling a motor vehicle in certain drive conditions which greatly improves the motor vehicles fuel economy.

One advantage of the present invention may be that it provides for an improved hybrid drive assist system.

A further advantage of the present invention may be that it provides for an electric powered out drive system that is easy to install and is a completely self contained, self operating unit that requires little or no telematic data from the vehicle onboard computer or sensors.

A further advantage of the present invention may be that it provides for an electric powered out drive that automatically moves a drive wheel between a storage position and a drive position depending on the vehicle parameters, such as speed, direction of travel, etc.

Still another advantage of the present invention may be that it provides for an electric powered out drive that is capable of being plugged into a standard 120 volt AC outlet to recharge the onboard batteries that drive the drive wheel of the electric powered out drive.

Yet another advantage of the present invention may be that it provides for an electric powered out drive that has its own self contained onboard system controller that will control the electric motor output power as well as the drive wheel of the electric powered out drive.

Yet another advantage of the present invention may be that it provides for a light weight easy to use vehicle assist system that is capable of providing a 15 to 60 percent improvement in mileage to an internal combustion engine via a five to twenty horse power assist by an electric motor of the electric powered out drive.

Still another advantage of the present invention may be that it provides for an electric powered out drive that is easily attached to a motor vehicle via a trailer hitch receiver or custom mount bracket on the motor vehicle used therein.

Still another advantage of the present invention may be that it provides for an electric powered out drive that conveniently stores itself during parking of the car, such that the electric vehicle out drive does not have to be removed from the vehicle to be parked in a garage, in a standard sized parking spot, etc.

Yet another advantage of the present invention may be that it provides for an electric powered out drive that includes an onboard accelerometer to determine direction and acceleration of the vehicle, etc.

Other objects, features and advantage of the present invention will become apparent from the subsequent description and appended claims, taken in conjunction with the accompanying drawings.

### BRIEF DESCRIPTION OF THE DRAWINGS

FIG. 1 shows a side view of an electric powered out drive in its drive position attached to a vehicle according to the present invention.

FIG. 2 shows a top view of the electric powered out drive in its storage position attached to a vehicle according to the present invention.

FIG. 3 shows an end view of the electric powered out drive in its drive position attached to the vehicle according to the present invention.

FIG. 4 shows an end view of the electric powered out drive in its storage position attached to a vehicle according to the present invention.

FIG. 5 shows a methodology of controlling an electric powered out drive according to the present invention.

### BRIEF DESCRIPTION OF THE PREFERRED EMBODIMENT(S)

Referring to the drawings, there is shown a hybrid electric powered out drive system 10 according to an embodiment of the present invention. The electric powered out drive system 10 of the present invention is a self contained electric drive system that can be charged within an approximate three to six hour time interval by means of a standard 120 volt AC wall outlet found in most homes and business. The electric powered out drive system 10 generally is attached to the rear of any vehicle 12 by a standard trailer hitch receiver 14 and/or in another contemplated embodiment may incorporate a custom mounting bracket to assist securing of the electric powered out drive 10 to the rear of the vehicle 12. Generally, the electric powered out drive 10 will assist in propelling a motor vehicle 12 during certain driving conditions which may greatly improve the vehicles 12 fuel economy. It should be noted that the embodiment shown in the present invention is for use on a motor vehicle or automobile, however any other type of vehicle, such as but not limited to motorcycles, off road vehicles, any type of motor vehicle including hybrid vehicles, all electric vehicles, fuel cell vehicles, diesel vehicles and any known type of internal combustion engine vehicle may also be used with the electric powered out drive system 10 of the present invention. The electric powered out drive 10 typically will improve fuel economy of an internal combustion engine by approximately 15 to 50% depending on the vehicle and driving conditions in which the vehicle is used. This may translate into an approximate 15 to 60 percent improvement in gas mileage over the EPA rated fuel economy. The self contained electric powered out drive 10 only connection to the vehicle 12 is the trailer wiring hookup of the internal combustion vehicle 10. The out drive system 10 will assist the vehicle 12 to move during predetermined conditions with an approximately five to twenty horsepower electric motor attached to the electric powered out drive system 10. Generally, the electric powered out drive system 10 may provide 50 to 60 pounds of down force onto the drive wheel to ensure proper assisting from the drive wheel of the electric powered out drive 10 to the internal combustion vehicle 12 that it is connected thereto. In one contemplated embodiment one single charge of the battery system of the electric powered out drive system 10 may be able to assist movement of the vehicle 12 for approximately 50 miles. It should be noted the range may be much higher. It should also be noted that the entire electric powered out drive system 10 is easy to build, light weight and is very easy to install and operate on the internal combustion vehicle 12. In one contemplated embodiment the electric powered out drive system 10 may extend approximately 16 to 17 inches from the end or bumper of the vehicle 12 and only weighs approximately 200 pounds. It should further be known that it is contemplated to use the electric powered out drive system 10 with any known receiver hitch having a class two or higher rating. It should further be noted that the electric powered out drive system 10 operates and assists during predetermined conditions which will be described hereafter.

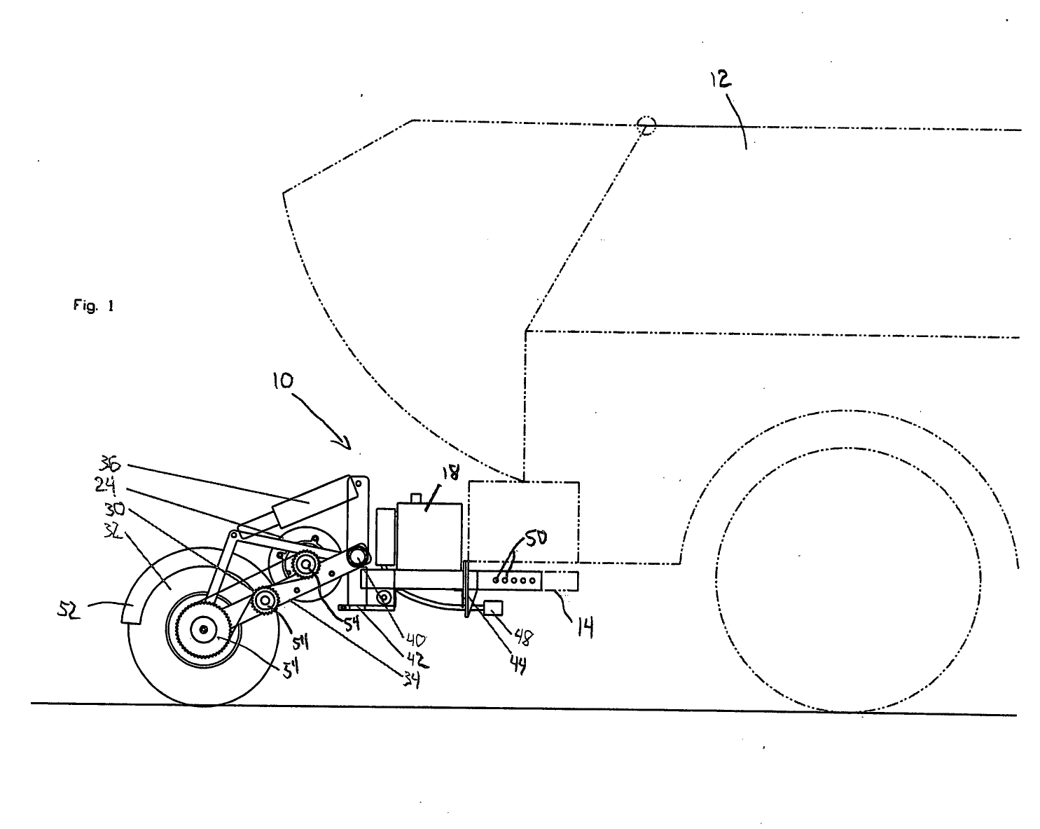

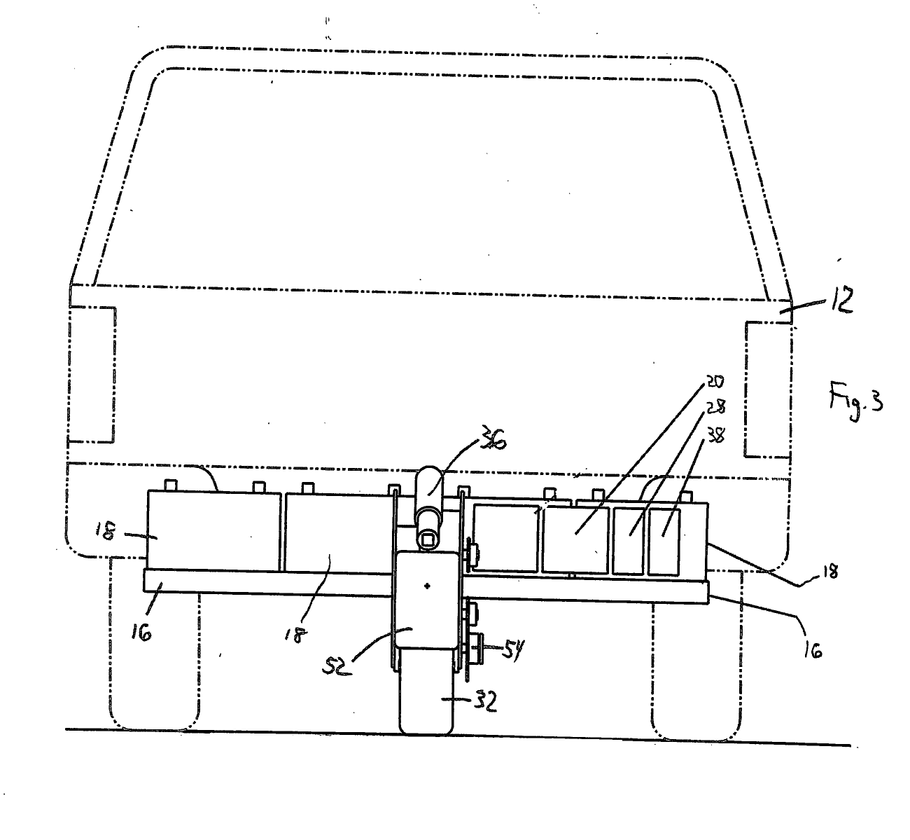

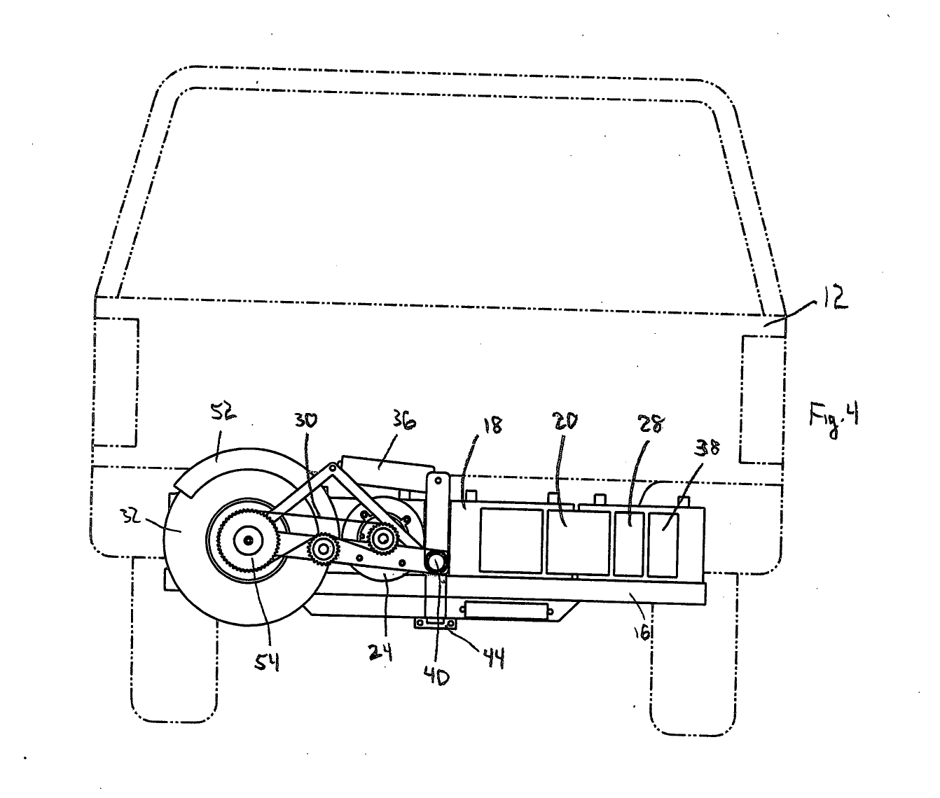

In the embodiment shown in FIGS. 1 through 4 the electric powered out drive system 10 is a self contained electric drive system 10 that generally comprises a battery storage compartment or housing 16, at least one battery 18, a battery charger 20, a power relay 22, an electric motor 24, a motor controller 26, a system controller 28, a transmission 30, a drive wheel 32, a swing arm 34, an air shock 36, an air compressor 38, a suspension pivot 40, a steering pivot 42, an adjustable mount 44, an accelerometer 46, and a trailer wiring harness 48. In another contemplated embodiment a global positioning system may also be affixed to the self contained electric powered out drive system 10.

The electric powered out drive system 10 of the present invention generally includes a housing 16 that may or may not be completely enclosed and that generally has a rectangular shape when viewed from above. This housing 16 generally will be used to hold at least one battery therein. One contemplated embodiment uses a plurality of batteries 18 arranged within the housing 16. In the embodiment shown four lead acid batteries 18 are arranged within the housing 16 and are connected to one another. However, it should be noted that it is also contemplated to use any other type of battery, such as but not limited to, lithium ion or any other known or unknown battery type that provides the same electrical potential as traditional lead acid batteries, but provide the electrical potential at a much lighter weight and lower costs to the manufacturer of the electric powered out drive system 10. It should be noted that the housing 16 may extend a predetermined distance from the bumper or rear portion of the vehicle 12 and may extend a predetermined distance along the width of the bumper. Generally, the housing 16 width will be less than the overall width of the internal combustion engine vehicle 12 onto which the housing 16 is affixed. It should further be noted that the overall dimensions of the housing 16 may vary depending on the size of the batteries 18 and other equipment and components that have to be arranged within the housing 16. The system 10 also includes a battery charger 20 which is electrically connected to the batteries 18 and is capable of charging the batteries 18 by plugging into a standard 120 volt AC wall outlet typically found in residential and business settings. Any known electrical wiring may be used to connect the battery charger 20 to the batteries 18 and the batteries 18 to the other components of the electric powered out drive system 10. The housing 16 is engaged and secured to an adjustable mount member 44. The adjustable mount member 44 is used to secure the electric powered out drive system 10 to the vehicles trailer hitch receiver 14. It should be noted that it is also contemplated to connect the adjustable mount member 44 to a custom mount bracket created for the vehicle 12 that operates in a manner similar to that of a trailer hitch receiver. The adjustable mount member 44 may have a plurality of orifices 50 therethrough to ensure locking of the adjustable mount member 44 to the trailer hitch receiver to ensure the electric powered out drive system 10 stays securely attached to the vehicle in a predetermined position. Generally, the housing 16 may be arranged on a top surface of the mount member 44.

The electric powered out drive system 10 may also include a steering pivot 42 that is secured to the adjustable mount member 44 at a predetermined position to accommodate different height motor vehicles when the elective powered out drive 10 is installed to the vehicle 12. Any known fastener or mechanical or chemical fastening technique may be used to connect the steering pivot 42 to the mount member 44. The system 10 also includes a suspension pivot 40 that is attached and secured to the steering pivot 42, which will allow the drive wheel 32 of the system 10 to turn with the motor vehicle 12 and will allow for the drive wheel 32 to swing into a storage position when not in use. The suspension pivot 40 generally will have a cylindrical shape and may be pneumatically controlled via an air compressor 38 arranged on the electric powered out drive system 10. The system 10 also includes a swing arm 34 that is attached to the suspension pivot 40 on one end and to the drive wheel 32 on the opposite end of the swing arm 34. The system 10 further includes an air shock 36 that is arranged between the steering pivot 42 on one end and the drive wheel 32 on the opposite end. The drive wheel 32 may also include a fender 52 arranged thereover and the appropriate frame to support the fender 52. The air shock 36 places the drive wheel 32 into its proper position with relation to the vehicle 12 and road during the assisting. The system 10 also includes an electric motor 24 that is connected to and engaged with the swing arm 34 and is coupled to the drive wheel 32 via a transmission 30. In the embodiment shown the transmission 30 is in the form of a belt drive that includes at least two sprockets 54 that interact with the belt to provide and transfer power between the electric motor 24 and the drive wheel 32. In one contemplated embodiment three sprockets 54 may be used to guide the belt between the drive wheel 32 and the electric motor 24. However, it should be noted that it is contemplated to use a chain or any other type of drive system to transfer the rotational torque of the electric motor 24 to the drive wheel 32. In the embodiment shown a motorcycle type drive belt is used. It should be noted that it is also contemplated to put the appropriate covers over the drive belt to ensure proper operation and protection of the transmission 30 from road debris and the like in the vehicle environment. It should further be noted that any type of electric motor 24 can be used, preferably one that provides five to twenty output horse power that is passed, via the transmission 30, to the drive wheel 32 to assist the vehicle 12 during predetermined driving conditions. It should be noted that any known parameters and sizes may be used for any of the above mentioned mechanical components of the electric powered out drive system 10. It should further be noted that generally most of the components are made of a metal material, however any other type of metal, plastic, ceramic, composite, or natural material may be used for any of the components described above or hereafter.

The electric powered out drive system 10 also includes a power relay 22 that is secured to a predetermined portion of the housing 16 or other component of the electric powered out drive system 10. The power relay 22 connects the batteries 18 to the electric motor 32. Furthermore, the electric powered out drive system 10 includes a motor controller 26 which is controlled by a system controller 28 which is also arranged on a predetermined portion of either the housing 16 or other component of the electric powered out drive system 10. It is contemplated to have the motor controller 26, power relay 22, system controller 28, compressor 38 and accelerometer 46 arranged within the housing 16 to protect them from road grime and the environmental factors associated with using the electric powered out drive 10 during on road operation. However, it is also contemplated to have a self contained separate unit that is attached to the housing 16 or other portion of the electric powered out drive system 10 to ensure proper protection of the motor controller 26, system controller 28, accelerometer 46, compressor 38 and power relay systems 22. The electric powered out drive system 10 also includes an air compressor 38 secured to the housing 16 at a predetermined position thereon. The air compressor 38 generally will be in communication with and connected pneumatically to the air shock 36 of the system 10 which will provide the proper and necessary downward force on the drive wheel 32 to ensure proper contact with the road when the drive wheel 32 is in its drive position. The air compressor 38 may also be connected to the suspension pivot 40, swing arm 34 or steering pivot 42 if pneumatic or air is needed to move these systems to predetermined positions. However, it is also contemplated to use electronic solenoids to replace the air shock 36 and air compressor 38 and any other pneumatic system on the present invention. The use of electronic solenoids will provide for more precise movement and less weight in the contemplated embodiment.

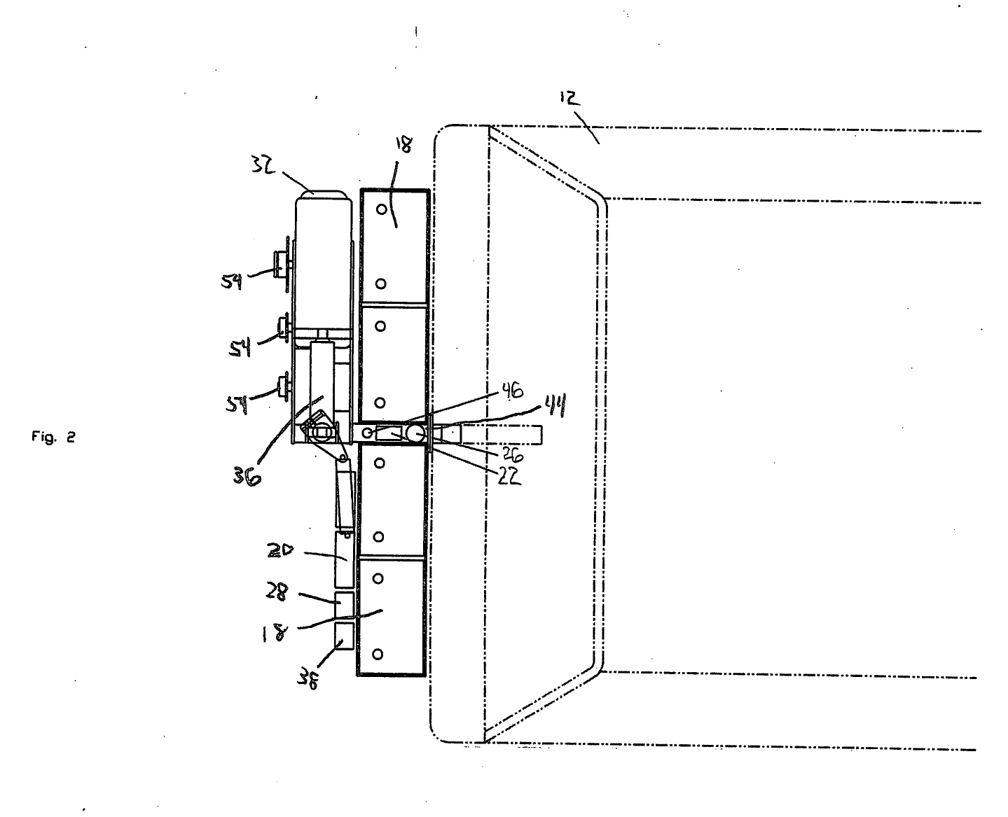

The electric powered out drive system 10 is capable of automatically moving the drive wheel 32 and associated swing arm 34 and electric motor 24 between a drive position, wherein the drive wheel 32 and swing arm 34 are generally in a perpendicular position with relation to the bumper or rear end of the vehicle 12 when viewed from above. The electric powered out drive system 10 also is capable of automatically moving the drive wheel 32 into a storage position, wherein the drive wheel 32 and swing arm 34 are generally parallel to the bumper or rear end of the vehicle 12 when viewed from above. The automatic movement relies on sensor inputs collected by the system controller 28 of the electric powered out drive 10 and the calculations performed on such sensor inputs to determine if the drive wheel 32 should be in the drive position as shown in FIG. 1 or in a storage position as shown in FIG. 2. It should be noted that the electric powered out drive system 10 is completely self contained and autonomous from the vehicle computers and telematic systems. The onboard system controller 28 makes all decisions as to if the drive wheel 32 should be in the drive position or storage position and does not rely on any information other than that garnered through a standard trailer wiring harness from the vehicle 12.

During operation of the electric powered out drive system 10 the system controller 28 controls the electric motor 24 output power as well as the drive wheel 32 position, i.e., the drive position or storage position, in order to best optimize the amount of energy stored in the batteries 18. The system controller 28 may monitor and use some or all of the following inputs to make determinations regarding the electric motor 24 output power and the drive wheel 32 position and speed, the battery voltage, the electric motor voltage, the electric motor current, the electric motor temperature, if the brake lights and parking lights of the motor vehicle are in use, etc. The brake and parking lights information is gathered via the trailer wiring harness 48 that is part of the electric powered out drive system 10. It should be noted that the trailer wiring harness 48 is electrically connected to the system controller 28 via any known wires and to the vehicle trailer wiring harness receptacle of the vehicle 12. It should also be noted that the accelerometer 46 is arranged and secured to either an outside surface of the housing 16 or an inside surface of the housing or some other component of the electric powered out drive system 10 in order to provide input to the system controller 28 regarding vehicle acceleration and movement of the vehicle 12 in either a forward or rearward direction.

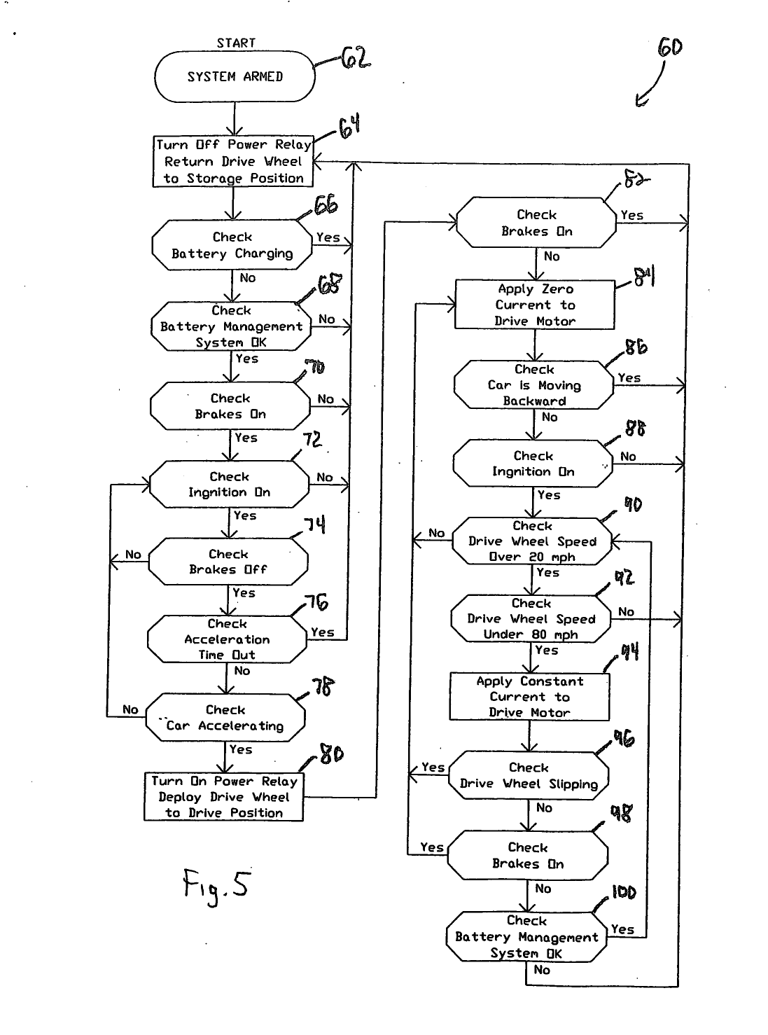

FIG. 5 shows a flow chart of one embodiment of a methodology to control the system controller 28 in order to determine if the drive wheel 32 should be placed in a storage position or the drive position and the amount of power to be sent from the electric motor 24 to the drive wheel 32 via the transmission 30. The system controller 28 may also manage all functions related to the operation of the system 10 including but not limited to the drive position of the wheel 32, the storage position of the wheel 32, electric motor 24, the motor controller 26, batteries 18, the battery charger 20, the power relay 22, the air shock 36 and the air compressor 38. The management of all these functions may be achieved by monitoring and using some or all of the following inputs such as battery voltage, battery current, electric motor voltage, electric motor current, electric motor temperature, steering pivot position, the suspension pivot position, the accelerometer input, in input from the brake lights and ignition and parking lights via the trailer wiring harness 48.

The system controller methodology 60 generally may monitor and react to four system controller subsystems. These system controller subsystems generally are activation conditions to determine drive position, electric motor output on conditions, electric motor output off conditions, and deactivation conditions to determine if the drive wheel should be placed into the storage position.

In the activation conditions module the system controller 28 determines and senses if the batteries 18 are charged properly and if the car ignition is on. The car ignition is determined to be on by sensing if the brake light voltage is above a preset value. Next, the system controller 28, via the accelerometer 46 inputs, senses forward motion and if the brake light signal is off via the trailer wiring harness 48. Then the system controller 28 activates the electric powered out drive system 10 by turning on the power relay 22 and the air shock 26 will swing the drive wheel 32 out and down into the drive position ensuring proper contact with the road. The system controller 28 then monitors and senses positive electric motor voltage or forward motion and will then scan through the motor output on conditions module and the deactivation conditions module to ensure the drive position should be maintained.

In the electric motor output on conditions module, the system controller 28 will sense when the motor vehicle speed is above a predetermined set point at which point the system controller 28 will increase the current to the electric motor 24 to a constant current set point at a predetermined set ramp rate. This predetermined constant current set point will be lowered if the electric motor temperature is sensed to be greater than a predetermined motor temperature set point which indicates that the motor 24 is overheating. The system controller 28 will then monitor and scan through the electric motor output off conditions module and the deactivation conditions module.

In the electric motor off conditions module, the system controller 28 will make the electric motor output current zero when the electric motor voltage drops below a predetermined set point, such that it determines the vehicle is moving too slow or is stopped. The system controller 28 may also set the electric motor output current to zero if the electric motor voltage rises at a rate greater than a predetermined rise rate set point which indicates that the drive wheel 32 is slipping. The output current will also be set to zero if the electric motor current goes above a maximum predetermined current set point which will protect the electric motor 24 from over current. The system controller 28 may also set the electric motor output current to zero if the system controller 28 detects that the brake light input from the trailer hitch wiring harness 48 is activated, this shows that the operator has applied the brakes to the vehicle. It should be noted that in this condition the drive wheel 32 may still stay in the drive position. The system controller 28 then monitors and scans through the electric motor output on conditions module and the deactivation conditions module.

The deactivation conditions module is used to determine if the drive wheel 32 should be placed in the storage position. The system controller 28 will deactivate the electric power out drive 10 when the electric motor voltage is negative which shows that the drive wheel 32 is moving in a backwards direction. It will also deactivate the system 10 when the electric motor voltage has been zero for longer than a predetermined shut down time or set point, which shows that the vehicle 12 has not moved for a predetermined amount of time and if the brake light signal is off, shows that the vehicle is in park. The system controller 28 will also deactivate the system 10 and put the drive wheel 32 in the storage position if the parking light input from the trailer wiring harness 48 is deactivated along with the electric motor voltage being zero which shows that the operator requested a shut down. The system controller 28 will also deactivate the system 10 if the electric motor temperature is greater than a maximum predetermined motor temperature set point which ensures that over temperature safety shut down occurs where needed. The system controller 28 also deactivates the system 10 when its senses and determines that the battery voltage falls below a predetermined minimum battery voltage set point. This will ensure that a low battery voltage shut down occurs and damage does not occur to the electric motor 24 or other systems onboard. The system controller 28 will also deactivate the system 10 after it determines and calculates that the battery 18 has used approximately 90% of its capacity. If any of these conditions are met the system controller 28 sends instructions to raise the suspension pivot 40 and rotate the steering pivot 42 approximately 90° to the storage position and turn off the power relay 22 thus ensuring no power is being passed between the batteries 18 and the electric motor 34. Next, the system controller 28 will scan through the activation conditions module to determine if the drive wheel 32 should be placed back into its drive position.

As shown in FIG. 5 the methodology 60 of controlling the electric powered out drive system 10 starts in box 62 by initializing and arming the system controller 28 and associated electronics on the electric powered out drive system 10. Next in box 64, the system controller 28 will turn off the power relay 22 in the electric powered out drive system 10 thus returning the drive wheel 32 to its storage position off of the road. Next in box 66, the methodology will check to see if the battery 18 is charging. If the battery 18 is charging the methodology returns to box 64. If the battery 18 is not charging, the methodology enters box 68 to check if the battery management system is operating correctly and that the battery 18 is properly charged and within the proper operating parameters. If the battery management system is not operating correctly, the methodology returns to box 64. If the battery management system is operating correctly, the methodology enters box 70 to determine if the vehicle brakes are on or applied. If the brakes are not on the methodology returns to box 64. If the vehicle brakes are on the methodology enters box 72 to determine if the ignition of the vehicle is on. If the ignition is not on the methodology returns to box 64. If the ignition is on the methodology enters box 74 to determine if the brakes of the vehicle are off. If the brakes of the vehicle 12 are not off the methodology returns to box 72. If the vehicle brakes are off, the methodology enters box 76 to determine if an acceleration time out has occurred. If the acceleration time out has occurred the methodology returns to box 64. If the acceleration time out has not occurred, then the methodology enters box 78 to determine if the vehicle 12 is accelerating. If the vehicle 12 is not accelerating, the methodology returns to box 72. If the vehicle is accelerating the methodology enters box 80 and the system controller 28 turns on the power relay 22 which will in turn deploy the drive wheel 32 to the drive position, wherein the drive wheel 32 engages the road at a predetermined position.

Next, the methodology enters box 82 to determine if the brakes of the vehicle have been applied. If the brakes have been applied the methodology returns to box 64. If the brakes of the vehicle 12 have not been applied, the methodology enters box 84 where the system controller 28 will apply zero current to the electric motor 24. The methodology then enters box 86 to determine if the vehicle 12 is moving backwards. If the vehicle 12 is moving backwards, the methodology returns to box 64. If the vehicle 12 is not moving backwards, the methodology enters box 88 to determine if the ignition of the vehicle 12 is on. If the ignition of the vehicle 12 is not on the methodology returns to box 64. If the ignition of the vehicle 12 is on, the methodology enters box 90 to determine if the drive wheel 32 speed is greater than a predetermined set point. If the drive wheel 32 speed is not greater than the predetermined set amount, the methodology returns to box 84. If the drive wheel speed is over the predetermined set point, the methodology will enter box 92 to determine if the drive wheel 32 speed is less than or under a predetermined set point or amount. If the drive wheel 32 speed is not under the predetermined set amount the methodology will return to box 64. If the drive wheel 32 speed is under a predetermined amount, the methodology enters box 94 and the system controller 28 applies a constant current to the electric motor 24, thus allowing the electric motor 24 to drive the drive wheel 32 at a constant rate to help assist movement of the vehicle 12. Next, the methodology enters box 96 to determine if the drive wheel 32 is slipping. If the drive wheel 32 is slipping, the methodology returns to box 84 where a zero current is applied to the electric motor 24. If the drive wheel 32 is not slipping, the methodology enters box 98 to determine if the brakes of the vehicle 12 are on or have been applied. If the brakes of the vehicle 12 have been applied, the methodology returns to box 84 where the system controller 28 will apply zero current to the electric motor 24. If the brakes of the vehicle 12 have not been applied, the methodology enters box 100 to determine if the battery management system is operating correctly and if the battery 18 is operating and charged as designed. If the battery management system is operating correctly, the methodology returns to box 90. If the battery management system is not operating correctly, the methodology will return to box 64 where the system controller 28 will turn off the power relay 22 and return the drive wheel 32 to the storage position. It should be noted that in one contemplated embodiment the lower set point for the drive wheel speed is approximately 20 miles per hour, while the upper set point for the drive wheel speed is approximately 80 miles per hour, however any other upper and lower range limits may be used for the drive wheel 32 depending on the design requirements and environment in which the electric powered out drive system 10 is used. It should be noted that the system 10 also may monitor the charging and discharging of the batteries 18 to optimize the performance and maintenance of the overall electric powered out drive system 10.

The present invention has been described in an illustrative manner. It is to be understood that the terminology which has been used is intended to be in the nature of words of description rather than that of limitation.

Many modifications and variations of the present invention are possible in light of the above teachings. Therefore, within the scope of the appended claims, the present invention may be practiced otherwise than as specifically described.

What is claimed is:

1. An electric powered out drive system for use with a vehicle, said system comprising:
a housing;
at least one battery arranged in said housing;
an adjustable mount member contacting said housing and the vehicle;
a steering pivot connected to said mount member;
a wheel attached to an end of said swing arm;
an air shock arranged between said steering pivot and said wheel;
a suspension pivot connected to said steering pivot; and
an electric motor secured to said swing arm and in communication with said wheel.

2. The system of claim 1 further comprising a battery charger connected to said battery.

3. The system of claim 1 further comprising a power relay connected to said battery and connected to said electric motor.

4. The system of claim 1 further comprising a motor controller in communication with said electric motor.

5. The system of claim 1 further comprising a system controller in communication with a power relay, a motor controller, said battery and said electric motor.

6. The system of claim 1 further comprising a transmission arranged between said wheel and said electric motor.

7. The system of claim 1 further comprising an air compressor connected to said air shock.

8. The system of claim 1 further comprising an accelerometer secured to said mount member and in communication with a system controller.

9. The system of claim 1 further comprising a trailer wiring harness.

10. The system of claim 1 wherein said wheel automatically moves between a drive position and a storage position depending on parameters sensed by the out drive system.

11. The system of claim 1 wherein said electric motor provides approximately five to twenty horsepower to assist movement of the vehicle.

12. An electric hybrid system for use with a vehicle, said system comprising:
a trailer hitch receiver secured to the vehicle; and
a self contained electric powered out drive engaged with and secured within said trailer hitch receiver, said out drive having a wheel that automatically moves between a drive position and a storage position depending on parameters sensed by said out drive.

13. The system of claim 12 wherein said out drive having an onboard system controller, accelerometer, battery, electric motor and a trailer wiring harness.

14. The system of claim 13 wherein said trailer wiring harness is in communication with the vehicle, said system controller monitors brake lights and parking lights of the vehicle.

15. The system of claim 13 wherein said system controller controls an output power of said electric motor and controls a position of said wheel.

16. The system of claim 13 wherein said system controller monitors said accelerometer, said system controller monitors a voltage of said battery and monitors a voltage, a current, and a temperature of said electric motor.

17. The system of claim 12 wherein said drive position having said out drive generally perpendicular to an end of the vehicle when viewed from above, said storage position having said out drive generally parallel to said end of the vehicle when viewed from above.

18. A method of controlling an electric powered out drive for use with a vehicle, said method compromising the steps of:
initializing a system controller onboard the out drive;
determining a status of predetermined out drive activation conditions;
deploying a drive wheel if said predetermined out drive activation conditions are satisfied;
monitoring electric motor output on conditions;
monitoring electric motor output off conditions;
monitoring predetermined out drive deactivation conditions; and
returning said drive wheel to a storage position if said predetermined out drive deactivation conditions are satisfied.

19. The method of claim 18 wherein said determining step further comprises the steps of:
determining if a battery on board the out drive is charged and working properly;
determining the status of the vehicle brakes and ignition; and
checking a status of an accelerometer on board the output drive to determine if the vehicle is moving forward.

20. The method of claim 18 wherein said step of monitoring electric motor output on conditions further comprises the steps of:
determining if the vehicle speed is greater than a predetermined speed;
determining if a temperature of said electric motor is greater than a predetermined electric motor temperature; and
applying a constant current to said electric motor if predetermined conditions are satisfied.

21. The method of claim 18 wherein said step of monitoring electric motor on conditions further comprises the steps of:
determining if the vehicle is moving to slow or is stopped;
determining if said drive wheel is slipping;
determining if a current of said electric motor is greater than a predetermined current set point;
determining if brakes of the vehicle have been applied; and
applying a zero current to said electric motor if predetermined conditions are satisfied.

22. The method of claim 18 wherein said step of monitoring out drive deactivation conditions further comprises the steps of:
determining if said drive wheel is moving backwards;
determining if the vehicle has not moved for a predetermined amount of time and if the vehicle is in park;
determining if the vehicle parking light is deactivated and if said electric motor voltage is zero;
determining if said electric motor temperature is greater than a predetermined maximum temperature;
determining if a battery voltage is less than a predetermined minimum voltage; and
determining a capacity remaining of said battery.
